(19) United States
(12) Patent Application Publication
(10) Pub. No.: US 2002/0075937 A1
(43) Pub. Date: Jun. 20, 2002

(54) Grooved/trenched lid for temperature measurements

(75) Inventors: John Heon Yi, Austin, TX (US); Terry Marquis, Austin, TX (US); Raymond S. Duley, Buda, TX (US); Thomas S. Tarter, San Jose, CA (US)

Correspondence Address: Kelly K. Kordzik, Suite 800, 100 Congress Avenue, Austin, TX, 78701, US

(73) Assignee: Advanced Mirco Devices

(21) Appl. No.: 09/739,853

(22) Filed: Dec. 18, 2000

(51) Int. Cl. G01K 7/04; G01K 1/14

(52) U.S. Cl. 374/179; 374/152

(57) ABSTRACT

An apparatus and method for measuring microprocessor case temperatures during testing. A groove is formed on a top surface of a lid covering a microprocessor, extending from an edge of the lid toward the center of the lid, in order to accept an insulated portion of a thermocouple. Depending on the size and shape of a sensing end of the thermocouple, either a step or notch may be formed at the interior end of the groove, near the center of the lid, to accept a sensing end of the thermocouple. Microprocessor case temperature is sensed during testing by the thermocouple, which is placed, and optionally bonded, within the groove and the step or notch.

### TECHNICAL FIELD

The present invention relates to the field of temperature measurement, and more particularly to the measurement of microprocessor operating temperatures.

### BACKGROUND

Microprocessors and other integrated circuit packages typically undergo a series of tests to ensure that they operate within certain design specifications, for example, specifications for environmental operating conditions. During such tests, the microprocessor generates heat and increases in temperature.

In order to prevent destruction of the microprocessor during testing, its temperature must remain within certain specified limits. Therefore, the temperature of a microprocessor undergoing testing must be accurately measured and controlled.

Testing of a microprocessor typically requires operation of the microprocessor in a testing package of a design that is known to those in the field of microprocessor testing and manufacture. Typically, such a known testing package comprises a substrate for receiving the microprocessor die, the substrate also providing electrical connections to enable operation of the microprocessor by a set of testing instructions passed to the microprocessor by testing software. Such a substrate receives the microprocessor die, which is then covered by a lid, the lid closing such that it secures the microprocessor within the substrate.

The testing package and microprocessor is then covered with a heat sink. The heat sink most often includes exterior fins that facilitate convective heat transfer between the heat sink and the surrounding atmosphere, which heat transfer is often aided by a controllable fan mounted in close proximity to the heat sink.

Microprocessor case temperature is measured by using a thermocouple to sense the temperature of the lid covering the microprocessor. Temperature measured at the center of the top surface of the lid approximates the actual microprocessor case temperature, and is considered a standard reference in the industry. A general discussion of the features and operation of a common thermocouple may be found in The Penguin Dictionary of Electronics, Second Edition, E. C. Young, pp. 579-580 (1988).

In order to provide accurate measurement of microprocessor case temperature, the small, active end of the thermocouple must be accurately placed on the lid so that it senses temperature as near as possible to the center of the top surface of the lid. Since the lid is covered by the heat sink during actual testing, a hole is drilled through the heat sink, through which the thermocouple is inserted so that its small, sensing end protrudes just below the heat sink and contacts the center of the lid.

This prior method of positioning the thermocouple for sensing microprocessor case temperature naturally requires exact alignment of the heat sink over the lid in order to accurately position the thermocouple. In addition, this prior method of positioning the thermocouple requires exact alignment of the thermocouple along the depth of the hole drilled through the heat sink, which is often difficult. If the thermocouple is not inserted far enough into this hole, it will not contact the lid and will not accurately sense microprocessor case temperature. In addition, when the lid, heat sink, and thermocouple are placed over the microprocessor, there is a possibility that the heat sink will be forced back up through the hole drilled through the heat sink, again resulting in inaccurate measurement of microprocessor case temperature.

The inaccurate measurement of microprocessor case temperature caused by these difficulties in positioning the thermocouple may create false test results. Otherwise defective microprocessors may pass testing, while non-defective microprocessors may fail testing and be discarded, thus diminishing quality control and decreasing productivity. Moreover, if the effects of these testing inaccuracies resulting from thermocouple alignment errors are observed, testing may be delayed or interrupted, which would also adversely impact microprocessor manufacturing productivity.

Accordingly, it would be desirable to provide a simple and accurate alternative to the present apparatus and method for measuring microprocessor case temperature.

### SUMMARY OF THE INVENTION

The present invention provides an apparatus and method for measuring microprocessor case temperatures. A groove is formed on atop surface of a lid covering the microprocessor, extending from an edge of the lid toward the center of the lid, in order to accept an insulated portion of a thermocouple. Depending on the size and shape of a sensing end of the thermocouple, either a step or notch may be formed at the interior end of the groove, near the center of the lid, to accept the sensing end of the thermocouple. Increases in accuracy are achieved by locating the groove and step slightly off-center relative to the lid.

Unlike the prior systems for measuring microprocessor case temperature, the apparatus and method of the present invention do not require exact alignment of the heat sink over the lid in order to accurately position the thermocouple. In addition, unlike these prior systems, the present invention does not require exact and often difficult alignment of the thermocouple along the depth of a hole drilled through the heat sink. Therefore, the present invention avoids many of the difficulties and shortcomings of these prior systems, thus decreasing the likelihood of false results, delays, or interruptions in testing.

The foregoing has outlined the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions, taken in conjunction with the accompanying drawings, in which:

FIG. 1 is a plan view of a thermocouple;

FIG. 2 is a perspective view of one embodiment of the apparatus of the present invention; and

FIG. 3 is a side cross-sectional view of one embodiment of the apparatus of present invention.

### DETAILED DESCRIPTION

Refer now to the drawings, wherein the depicted elements are not necessarily shown to scale and wherein like or similar elements are designated by the same reference numeral through the several views.

The present invention is described below in the context of measuring microprocessor case temperature using a thermocouple. However, it should be understood by those skilled in the art to which the present invention pertains that the apparatus and methods herein described are also generally applicable to any case temperature measurement of microprocessors, as well as other integrated circuits, wherein a temperature sensing device must be accurately positioned on a lid.

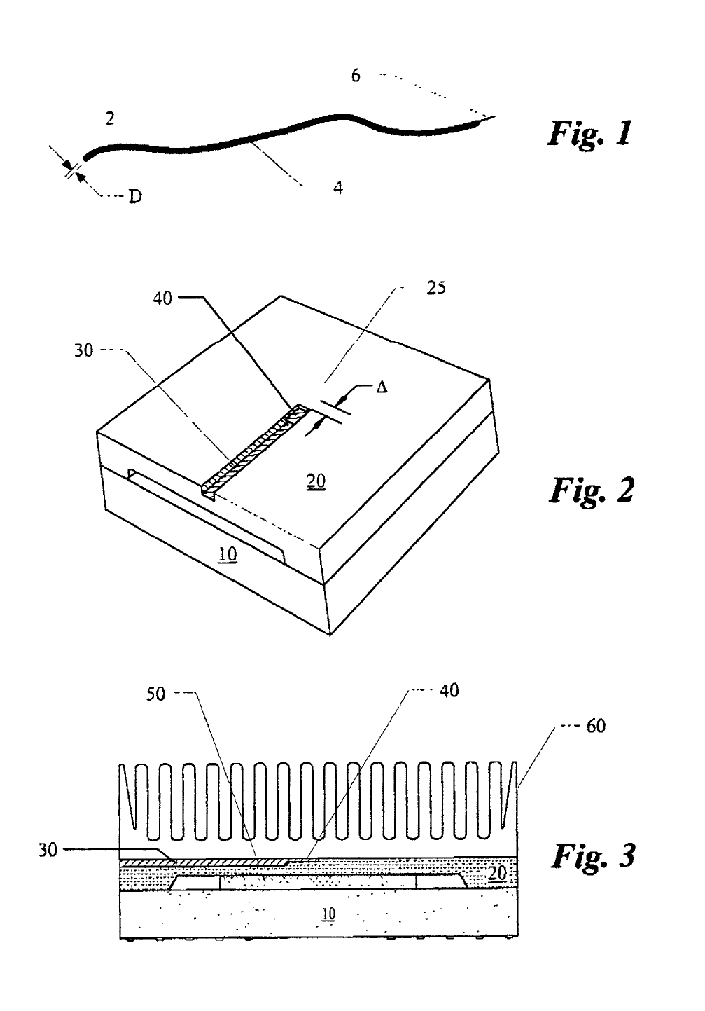

For reference throughout this specification, FIG. 1 illustrates a thermocouple 2. Thermocouple 2, like most thermocouples, includes an insulated portion 4 and a sensing end 6. Thermocouple 2 has a diameter D, which varies according to model and manufacturer. For measuring temperature, sensing end 6 of thermocouple 2 is placed in contact with a substance for which a temperature measurement is sought. Insulated portion 4 does not sense temperature.

FIGS. 2 and 3 illustrate a package substrate 10 for receiving a microprocessor die 50. The substrate 10 and microprocessor die 50 are covered by a lid 20. The lid 20 serves to retain microprocessor die 50 within the substrate 10. Lid 20 is most often covered by a heat sink 60. In this manner, testing of microprocessor die 50 may be accomplished by passing a testing instruction set through substrate 10 and to microprocessor die 50.

As discussed above, operation of microprocessor 50, whether during testing or normal use, generates heat. If not controlled, the heat generated by microprocessor 50 during operation will eventually degrade or destroy microprocessor 50. One method of controlling the temperature of microprocessor 50 during both testing and normal operation includes placing a heat sink 60 in contact with lid 20 to dissipate heat generated by microprocessor 50. The rate of heat dissipation provided by heat sink 60 may be regulated by locating a controllable fan (not shown) immediately above heat sink 60.

Referring now to FIGS. 1 through 3, unlike prior apparatus for measuring microprocessor case temperature, the apparatus of the present invention includes a means for simply and accurately positioning the thermocouple 2 near the center of lid 20. Rather than position thermocouple 2 by approximation, or by inserting it through a vertical hole (not shown) drilled through heat sink 60, a groove 30 or similar channel-type indentation is formed in lid 20 for accurately positioning thermocouple 2.

Depending on the particular thermocouple 2 used for measuring temperature, groove 30 is formed to a depth slightly greater than the diameter D of thermocouple 2, which provides a groove 30 which is just deep enough to receive and surround the insulated portion 4 of thermocouple 2. Therefore, when heat sink 60 is placed in contact with lid 20, thermocouple 2 is not crimped or otherwise damaged by pressure between lid 20 and heat sink 60. Groove 30 may be formed so as to originate from an edge of lid 20 and extend toward the center of lid 20. Although groove 30 may originate at any edge or corner of lid 20, originating groove 30 at roughly the center of a lateral edge of lid 20 causes less disturbance to the normal thermal properties of lid 20. Similarly, while groove 30 may proceed from its origin near an edge or corner of lid 20, along practically any path to the approximate center of lid 20, the shortest direct path to a position near the center of lid 20 is preferred.

When thermocouple 2 includes a sensing end 6 of different shape or size than the insulated portion 4, a corresponding shape is formed at the interior end of groove 30. When thermocouple 2 includes sensing end 6 that is smaller than the insulated portion 4, a step 40 may be formed at the interior end of groove 30. When the sensing end 6 of thermocouple 2 is larger than the insulated portion 4, a notch (not shown) may be formed in place of step 40. Naturally, when the sensing end 6 of thermocouple 2 is roughly the same size and shape as the insulated portion 4 of thermocouple 2, groove 30 may be formed of a single size. In any of these three cases, the sensing end 6 of thermocouple 2 should be properly positioned and oriented so as to sense temperature very near to the center of the top surface 25 of the lid 20.

In order to facilitate efficient testing of microprocessors, thermocouple 2 may be secured in its proper position within groove 30 and step 40, typically by bonding thermocouple 2 at its proper position within groove 30, and step 40 or the notch (not shown) with any standard bonding agent capable of use at relatively high temperatures, e.g., at or below 150 degrees Celsius.

As discussed above, the sensing end 6 of thermocouple 2 does not directly measure the temperature of microprocessor 50. Rather, this temperature is derived by measuring temperature at the center of the top surface 25 of lid 20. In this process, the thermal properties of the lid 20 are compensated for by calibrating temperature measurements so as to provide a close approximation of the actual temperature of the microprocessor 50.

Since existing testing packages are calibrated to compensate for the thermal properties of standard designs for lid 20, which designs would not include a groove 30, step 40, or the notch (not shown), the present invention also provides a means for compensating for the thermal effects of forming such a groove 30, step 40, or notch (not shown) on lid 20.

The effect on microprocessor case temperature caused by groove 30 and step 40 holding thermocouple 2 on the lid 20 is compensated for by locating the groove 30 and step 40 slightly off-center relative to the lid 2. In FIG. 2, groove 30 and step 40 are shown offset relative to the lid by a distance Δ. It has been shown empirically that choosing a distance Δin the range 1 to 3 mm provides accurate temperature measurement.

The present invention thus provides an apparatus useful for measuring microprocessor case temperature. In order to measure the temperature of microprocessors according to the present invention, a microprocessor die 50 is placed in a package substrate 10. Microprocessor 50 and substrate 10 are covered by a lid 20. Lid 20 includes a groove 30, and optionally, a step 40 or notch (not shown) adapted for receiving and positioning a thermocouple 2, as otherwise discussed above.

Next, thermocouple 2 is placed within groove 30, and optionally within the step 40 or the notch (not shown). Thermocouple 2 may also be secured in place by bonding with epoxy or other suitable temperature-resistant material. Lid 20 is then covered by a heat sink 60. Most typically, a controllable fan (not shown) is placed directly above and in close proximity to the heat sink 60.

Microprocessor 50 may then be operated for the purpose of testing by passing a testing instruction set passed to microprocessor 50 through substrate 10. Testing may then proceed and the microprocessor case temperature controlled according to the standard temperature feedback control methods, with temperature measurements provided by thermocouple 2 calibrated as discussed herein.

As can be seen from the above discussion, for measuring the temperature of microprocessors, the present apparatus and methods of the present invention do not require the difficult and often error-prone methods of positioning a thermocouple by feeding it through a hole drilled in the heat sink 60. Moreover, by securing thermocouple 2 in place within the groove 30, the step 40, or the notch (not shown), testing may be easily and accurately repeated without the necessity of re-positioning thermocouple 2.

Accordingly, the present invention provides an apparatus and method for measuring temperature during testing of microprocessors whereby a microprocessor 50 is placed in a substrate 10, which is covered by lid 20, the lid 20 including a groove 30 for receiving and accurately positioning a temperature sensitive thermocouple 2.

Although the present invention and its advantages have been described in detail, it should be understood that various changes, substitutions, and alterations can be made herein without departing from the spirit and scope of the invention as defined by the appended claims.

What is claimed is:

1. An apparatus for measuring the temperature of an integrated circuit comprising:
a socket adaptable for receiving the integrated circuit; and
a lid adaptable for covering the socket and the integrated circuit, the lid forming a groove on a top surface thereof adaptable for receiving a thermocouple.

2. The apparatus of claim 1 wherein the groove extends from a lateral edge of the lid to a position near the center of the lid.

3. The apparatus of claim 1 wherein the groove extends from a position near the center of a lateral edge of the lid, to a position near the center of the lid.

4. The apparatus of claim 2 wherein the lid forms a step at an interior end of the groove, the step being adapted for receiving a sensing end of the thermocouple.

5. The apparatus of claim 4 wherein the step has a depth different from a depth of the groove.

6. The apparatus of claim 2 wherein the lid forms a notch at an interior end of the groove, the notch being adapted for receiving a sensing end of the thermocouple.

7. The apparatus of claim 1 wherein the a depth of the groove is sufficient so that a heat sink can mate flush with the top surface of the lid when a thermocouple is mounted in the groove.

8. An apparatus comprising:
an integrated circuit;
a package substrate for receiving the integrated circuit;
a thermocouple; and
a lid covering the substrate and the integrated circuit, the lid forming a groove on a top surface thereof, wherein the groove extends from a lateral edge of the lid to a position approximate the center of the lid, the groove receiving the thermocouple.

9. The apparatus of claim 8 wherein the lid forms a step at an interior end of the groove, the step receiving a sensing end of the thermocouple.

10. The apparatus of claim 9 wherein the thermocouple is secured within groove and step.

11. The apparatus of claim 10 wherein the groove extends from a lateral edge of the lid to a position offset from the center of the lid by a distance in a range of 1 to 3 mm.

12. The apparatus of claim 8 wherein the lid forms a notch at an interior end of the groove, the notch being adapted for receiving a sensing end of the thermocouple.

13. The apparatus of claim 12 wherein the integrated circuit is a microprocessor package.

14. The apparatus of claim 8 further comprising a heat sink mounted flush on the top surface of the lid.

15. A method for measuring temperature of an integrated circuit during testing comprising the steps of:
placing an integrated circuit on a substrate;
covering the substrate and the integrated circuit with a lid, the lid forming a groove on a top surface thereof, wherein the groove extends from a lateral edge of the lid to a position approximate the center of the lid, the groove being adapted for receiving a thermocouple;
placing the thermocouple within the groove formed in the lid;
operating the integrated circuit; and
sensing the temperature of the integrated circuit with the thermocouple.

16. The method of claim 15 wherein the lid forms a step at an interior end of the groove, the step receiving a sensing end of the thermocouple.

17. The method of claim 16 further including the step of securing the thermocouple within groove and step.

18. The method of claim 17 wherein the groove extends from a lateral edge of the lid to a position offset from the center of the lid by a distance in a range 1 to 3 mm.

19. The method of claim 15 wherein the lid forms a notch at an interior end of the groove, the notch being adapted for receiving a sensing end of the thermocouple.

21. The method of claim 15 further comprising the step of mounting flush a heat sink to the top surface of the lid.
